(19) United States
(12) Patent Application Publication
(10) Pub. No.: US 2025/0265704 A1
(43) Pub. Date: Aug. 21, 2025

(54) DEVICE AND METHOD FOR ESTIMATING GROWING DAY OF FISH BODY

(71) Applicant: JJ & COMPANIES INC., Haeundae-gu (KR)

(72) Inventors: Joung Ho JEON, Gijang-gun (KR); Do Young KIM, Nam-gu (KR); Hyeon Seo PARK, Gijang-gun (KR)

(73) Assignee: JJ & COMPANIES INC., Haeundae-gu (KR)

(21) Appl. No.: 18/586,482

(22) Filed: Feb. 25, 2024

(30) Foreign Application Priority Data
Feb. 19, 2024 (KR) 10-2024-0023154

(51) Int. Cl. G06T 7/00

(52) U.S. Cl. CPC G06T 7/0012; G06T 2207/20081; G06T 2207/30004

(57) ABSTRACT

A method for estimating a growing day of a fish body according to an embodiment may comprise the steps of obtaining an image of a fish body using a camera; extracting a key point from the obtained image of the fish body; and estimating a growing day of the fish body based on the key point.

### RELATED APPLICATION

This application is a Paris Convention which claims the benefit of priority of Korean Patent Application No. 10-2024-0023154 filed on Feb. 19, 2024. The contents of the above application is all incorporated by reference as if fully set forth herein in its entirety.

### FIELD AND BACKGROUND OF THE INVENTION

An embodiment of the present invention relates to a device and method for estimating the growing day of a fish body, and specifically to a fish body biometric information analysis system.

In the aquaculture industry, large-scale fish farms and the advancement and platformization of aquaculture technology are in progress.

In particular, the aquaculture industry needs the development of unique technologies for quantitative and eco-friendly growth.

Research is being conducted to effectively cultivate fish through easy feed supply and seawater quality management, but there are many problems and solutions thereof are needed.

In order to solve this problem, a device and method for estimating the growing day of a fish body is proposed.

### SUMMARY OF THE INVENTION

A method for estimating a growing day of a fish body according to an embodiment may comprise the steps of obtaining an image of a fish body using a camera; extracting a key point from the obtained image of the fish body; and estimating a growing day of the fish body based on the key point.

The step of extracting according to an embodiment may comprise extracting a plurality of the key points from the obtained image of the fish body, and the step of estimating may comprise estimating the growing day of the fish body based on a length proportion between the key points.

The step of extracting according to an embodiment may comprise extracting the key point including a specific area of the fish body from the obtained image of the fish body.

The step of estimating according to an embodiment may comprise estimating the growing day of the fish body from a surface area of the specific area.

The camera according to an embodiment may comprise at least one single-lens camera.

The step of extracting according to an embodiment may comprise extracting an outline point of the fish body.

The step of estimating according to an embodiment may comprise estimating the growing day of the fish body using growth curve data.

The step of estimating according to an embodiment may comprise estimating a size of the fish body based on the growing day.

The step of estimating according to an embodiment may comprise estimating a mass of the fish body based on the growing day.

A device for estimating a growing day of a fish body according to an embodiment may comprise a fish body image obtaining unit that obtains an image of a fish body using a camera; a key point extraction unit that extracts a key point from the obtained image of the fish body; and a fish body growing day estimation unit that estimates a growing day of the fish body based on a length proportion between the key points.

### BRIEF DESCRIPTION OF THE SEVERAL VIEWS OF THE DRAWINGS

FIG. 1 is a flowchart of a method for estimating a growing day of a fish body according to an embodiment.

FIG. 2 is a diagram showing a method for estimating a growing day of a fish body according to an embodiment.

FIG. 3 is a diagram showing key points of a method for estimating a growing day of a fish body according to an embodiment.

FIG. 4 is a diagram showing key points settings of a method for estimating a growing day of a fish body according to an embodiment.

FIG. 5 is a diagram showing a process of a method for estimating a growing day of a fish body according to an embodiment.

FIG. 6 is a diagram showing a flow of a method for estimating a growing day of a fish body according to an embodiment.

FIG. 7 is a block diagram of a device for estimating a growing day of a fish body according to an embodiment.

### DESCRIPTION OF SPECIFIC EMBODIMENTS OF THE INVENTION

Hereinafter, embodiments of the present invention will be described in detail with reference to the accompanying drawings.

However, the technical spirit of the present invention is not limited to some of the embodiments described, and may be implemented in various other forms, and within the technical spirit of the present invention, one or more of the elements of the embodiments may be selectively combined and replaced.

In addition, unless expressly otherwise defined and described, the terms used in the embodiments of the present invention (including technical and scientific terms) may be construed the same meaning as commonly understood by one of ordinary skill in the art to which this invention belongs, and the terms such as those defined in commonly used dictionaries may be interpreted as having a meaning that is consistent with their meaning in the context of the relevant art.

Further, the terms used in the embodiments of the present invention are for describing the embodiments and are not intended to limit the present invention.

In this specification, the singular forms may also include the plural forms unless specifically stated in the phrase, and may include at least one of all combinations that may be combined in A, B, and C when described in “at least one (or more) of A and (with), B, and C”.

Further, in describing the elements of the embodiments of the present invention, the terms such as first, second, A, B, (a), and (b) may be used.

These terms are only used to distinguish the elements from other elements, and the terms are not limited to the essence, sequence, or order of the elements.

In addition, when an element is described as being “connected”, “coupled”, or “accessed” to another element, it may include not only when the element is directly connected to, coupled to, or accessed to other elements, but also when the element is “connected”, “coupled”, or “accessed” by another element between the element and other elements.

In addition, when described as being formed or disposed “on (over)” or “under (below)” of each element, the “on (over)” or “under (below)” may include not only when two elements are directly connected to each other, but also when one or more other elements are formed or disposed between two elements. Further, when expressed as “on (over)” or “under (below)”, it may include not only the upper direction but also the lower direction based on one element.

Hereinafter, exemplary embodiments of the present invention will be described in detail with reference to the accompanying drawings, in which like reference numerals refer to like or similar elements regardless of reference numerals and a duplicated description thereof will be omitted.

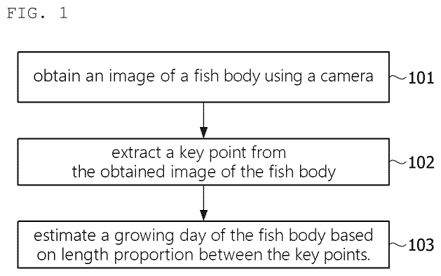

FIG. 1 is a flowchart of a method for estimating a growing day of a fish body according to an embodiment.

According to an embodiment, each step of the method for estimating a growing day of a fish body may be performed by at least some of the components of the device for estimating a growing day of a fish body, which will be described later.

In step 101, the device for estimating a growing day of a fish body may obtain an image of a fish body using a camera.

The camera may include at least some of a single-lens camera and a video input device/underwater environment sensor.

In step 102, the device for estimating a growing day of a fish body may extract a key point from the obtained image of the fish body.

In step 103, the device for estimating a growing day of a fish body may estimate the growing day of the fish body based on the key point.

The components of the device for estimating a growing day of a fish body may be configured to include at least some of a camera, machine, circuit, semiconductor, computing device, memory, processor, data transceiver, etc., and at least a portion each of component may be mechanically/physically/communicationally/electrically connected to at least a portion of the other components.

According to an embodiment, at least a portion of each component of the device for estimating a growing day of a fish body may include at least a portion of other components.

According to an embodiment, the device for estimating a growing day of a fish body may include at least some of all the components of the specification or drawings, and may perform at least some of all operations or functions of the specification or drawings.

According to an embodiment, the device for estimating a growing day of a fish body may extract a plurality of key points from the obtained image of the fish body and estimate the growing day of the fish body based on a length proportion between key points.

According to an embodiment, the device for estimating a growing day of a fish body may extract the key points including a specific area of the fish body from the obtained image of the fish body.

According to an embodiment, the device for estimating a growing day of a fish body may estimate the growing day of the fish body from the surface area of the specific area.

According to an embodiment, the camera may be at least one single-lens camera.

According to an embodiment, the device for estimating a growing day of a fish body may extract an outline point of the fish body.

According to an embodiment, the device for estimating a growing day of a fish body may estimate the growing day of the fish body using growth curve data.

According to an embodiment, the device for estimating a growing day of a fish body may estimate the size of the fish body based on the growing day.

According to an embodiment, the device for estimating a growing day of a fish body may estimate the mass of the fish body based on the growing day.

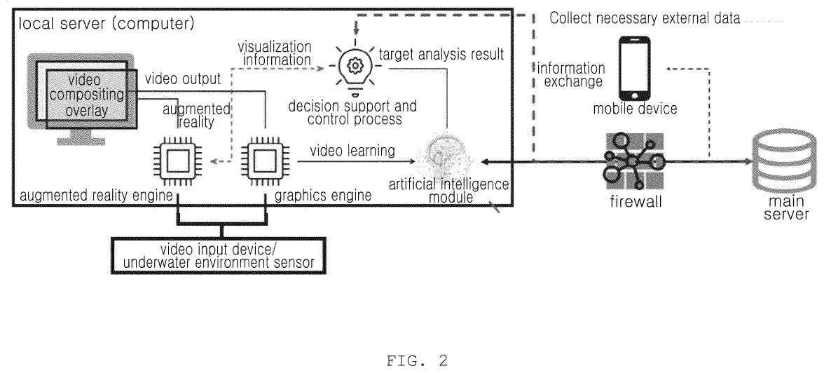

FIG. 2 is a diagram showing a method for estimating a growing day of a fish body according to an embodiment.

According to an embodiment, the device for estimating a growing day of a fish body uses a single-lens camera, and a plurality of cameras may be arranged on the upper side of a fish tank to take pictures in different directions. The device for estimating a growing day of a fish body may apply/use/provide technologies such as spatial mapping, probability distribution, and statistical analysis using a single-lens camera.

According to an embodiment, the device for estimating a growing day of a fish body may extract outline points (e.g., key points) of the fish body, extract 7 outline points, and compute/calculate a relative proportion between the outline points.

According to an embodiment, the device for estimating a growing a fish body may day of estimate/determine/compute/calculate the growing day of a fish body and estimate growth of the fish body rather than measuring the size of the fish body itself.

According to an embodiment, compared to the existing stereo camera method where a distance between cameras must be secured in advance and when shooting the fish body, the fish body must be parallel to a gap between lens arrays for the captured image to be valid, the device for estimating a growing day of a fish body uses a single-lens camera, so it is free from the fish body position and has high effective case extraction efficiency, and the camera price can be significantly reduced compared to the expensive stereo cameras.

According to an embodiment, the stereo camera method requires measuring the size of the fish body and extracting features separately, but in the device for estimating a growing day of a fish body, the estimation of the growing day after capturing the fish body may be performed/provided in a unified process.

According to an embodiment, the device for estimating a growing day of a fish body uses a single-lens camera instead of a stereo camera, uses spatial mapping, probability distribution, and statistical analysis techniques, and has a plurality of single-lens cameras to shoot in different directions (for example, the plurality of single-lens cameras may be disposed on the upper side of the fish tank). The device for estimating a growing day of a fish body may provide/perform a growing day estimation process and apply/provide a growth curve.

According to an embodiment, the device for estimating a growing day of a fish body may extract and use the outline points of the fish body and extract 7 outline points.

According to an embodiment, the device for estimating a growing day of a fish body may estimate the growing day of the fish body, and may estimate growth (growing day) of the fish body rather than measuring the size of the fish body itself.

According to an embodiment, the device for estimating a growing day of a fish body may provide a detailed process for estimating the growing day based on a captured image and the detailed process may be provided based on growth curve data.

According to an embodiment, the device for estimating a growing day of a fish body may include/use all estimable parameters and estimation processes in addition to the growing day, and may perform size and mass estimation based on the growing day.

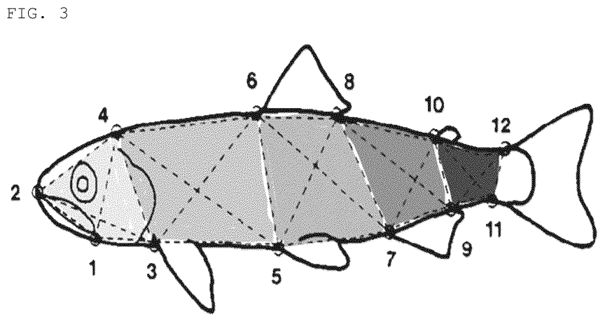

FIG. 3 is a diagram showing key points of a method for estimating a growing day of a fish body according to an embodiment.

When only a single underwater camera is used, a situation arises in which identification of an object becomes difficult due to changes in the shooting environment (sudden deterioration of water quality), chemical bathing (chemical treatment), etc. This means loss of data for identifying the growth of the object.

In a situation where continuous observation is important for growth management, installing filming equipment in various environments such as the upper surface and integrating the equipment into one system shows better results in terms of system operation than operating a single camera only underwater.

It is possible to observe population density and feeding activity through upper surface photography using multiple deployments of the cameras, i.e., rather than only underwater deployment of the cameras.

According to an embodiment, the device for estimating a growing day of a fish body may determine the growth rate and predict the optimal growth environment based on this.

By photographing the upper surface, it is possible to identify the population density that causes individual stress or determine the optimal rearing density. In addition, based on an installation structure that takes pictures from a fixed upper part to a lower part in a perpendicular direction, in case where it is impossible to predict the growing day based on key points, the device for estimating a growing day of a fish body may prevent the entire system from paralyzing, and even predict the length of the object based on the distance to the upper part and the pixel size of the object.

According to an embodiment, the device for estimating a growing day of a fish body may set 12 key points and then set 2 additional key points as follows.

| No. of key points | Description |
|---|---|
| No. 1 | protrusion point of the mouth |
| No. 2 | starting point of the jaw snout |
| No. 3 | starting point of the pectoral fin |
| No. 4 | starting point of head gill |
| No. 5 | front of the ventral fin |
| No. 6 | front of the dorsal fin |
| No. 7 | front of the anal fin |
| No. 8 | tip of the dorsal fin |
| No. 9 | Tip of the anal fin |
| No. 10 | starting of oil fin |
| No. 11 | upper starting point of the tail |
| No. 12 | starting point below the tail |
| No. 13 | middle starting point of the tail |
| No. 14 | maximum protrusion point of the gill |

In addition, in order to facilitate the calculation of various length ratios such as stereo camera, overall length, and body height, two additional key points are created at the convex part of the gills and the connection point with the tail, making a total of 14 key points.

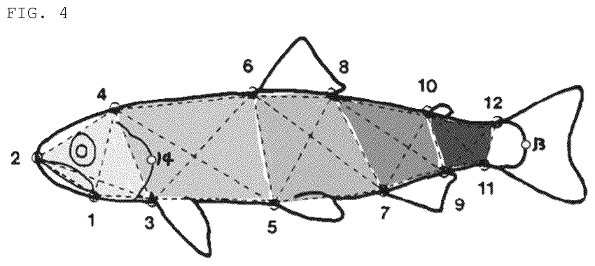

FIG. 4 is a diagram showing key points settings of a method for estimating a growing day of a fish body according to an embodiment.

The corresponding key point can be set in the same way as the 12 key points described above and additional 2 key points can be set.

First, the most convex part of the gill may be numbered 13, and the most concave part of the connection between the tail and body may be numbered 14.

According to an embodiment, the device for estimating a growing day of a fish body may estimate the ratio-based growing day through the key points.

There are several salmon objects measured by growing day, and the actual lengths of the head and body are measured according to designated key points. The proportion of the length of the object in time series order was shown by drawing a scatterplot.

This is the result of setting the object's key points to measure the object's growing day and selecting only the proportions of the body part of the object on the overall length according to the set key points.

Because there was a difference in the number of object sampling by measurement date and the possibility that some data may be biased, sampling data of less than 10 were excluded.

Analyzing the scatter plot, the body proportion of the object gradually decreases as it grows.

In other words, the torso proportion is gradually increasing compared to the growth of the head size in overall proportion, and the corresponding proportion shows negative linearity in the growing days and the torso: overall proportion until the 600th growing day.

As the proportion decreases, the growth rate of the fish body may be said to be high, and based on this, the relative growth compared to the current growing day may be determined.

The key point setting reference is the same as the method described above, and 14 key points may be set. The 14 key points set are applied equally to all objects. Through the key points, the feature area of the object is extracted after excluding the background where the object was photographed.

The key points are used to extract the external feature space for the entire area of the fish body, or the key points are also used because the consistent areas for each object may be extracted using the key points.

Through the key points, the overall visual feature area such as pattern and color of the fish body is calculated, and the growing day of the object is estimated by learning the feature area through a deep learning model.

The method for estimating a growing day of an object is based on the following assumptions.

Fish species such as Atlantic salmon are fish that change clearly in appearance as they grow.

It is a fish species with large relative changes, such as changes in the Parr mark and smoltification, and the growing day of the object is estimated based on the changes.

To estimate the growing day of the object, the external feature vector of the object is extracted through a CNN-based feature extractor. In this case, the feature vector refers to a feature vector that relies on comprehensive visual information such as color and external pattern.

Regression is performed based on the object's feature vector and the growing day of the object. In this case, linear regression is used for regression.

Based on the feature vector-based regression model created in this way, the growing day is predicted based on the external feature of the object.

The growing day estimation and growth curve principle applies the growing day deduced in the previous process to the growth curve and finally performs growth identification as well as the growing day.

The growth curve used to identify growth created each growth function, and the corresponding parameter derived the optimal parameter from the object in various habitat environments held by JJ&C, and the growth rate of the object may be identified based on the growing day, habitat environment information (temperature), and earliest weight.

According to an embodiment, the device for estimating a growing day of a fish body may determine the object's biometric information rather than the growing day through the following equation. The biometric information refers to actual measurements of the object, such as weight and length, that determine the growth rate of the object.

$${W}_{t} = {[ {W}_{0}^{b} - bc \frac{( T - {T}_{LIM} ) t}{\{ 100 ( {T}_{M} - {T}_{LIM} ) \}} ]}^{1 / b}$$

The definitions of the corresponding equation and each variable value are as follows.

| Param | Description |
|---|---|
| b | Mass conversion index showing linear growth over time |
| | (different for each species) |
| c | Growth rate of 1 g fish at optimal temperature |
| T | Average temperature for time t |
| T_{M} | Optimal growth temperature |
| T_{LIM} | Growth rate threshold temperature |
| TU | Maximum threshold temperature |
| TL | Minimum threshold temperature |
| t | Growth period to date (based on W0) |
| W₀ | Initial weight |
| Wt | Weight after day t |

Here, TU and TL do not exist in the equation. The optimal temperature T_{M} may be discussed for each species and environment, but the current reference is 15.84 Celsius. When an average rearing temperature is higher than T_{M}, the T_{LIM} growth rate threshold temperature becomes TU, and conversely, when the average rearing temperature is lower than T_{M}, T_{LIM} becomes TL.

In the case of b, it varies depending on the species, but the commonly used value of 0.31 was used. These figures are average for Atlantic salmon. The prediction identifies the object's biometric information by estimating the optimal c value for each growth stage.

According to an embodiment, the device for estimating a growing day of a fish body may have a total of 14 key points from the first key point to the fourteenth key point of the object.

The device for estimating a growing day of a fish body may obtain the total, head, and body lengths of the object through Nos. 2, 13, and 14 of the relevant points.

The straight line distances of Nos. 2 and 14 may be set as the head size, the distances of Nos. 13 and 14 may be set as the body length, and the straight line distances of Nos. 2 and 13 may be set as the overall body length.

In addition, based on the corresponding length, each proportion may be obtained using actual object size data.

The proportion is as follows.

| Name | Equation |
|---|---|
| Head: Overall | Overall length/Head length |
| Torso: Overall | Overall length/Torso length |

According to an embodiment, the device for estimating a growing day of a fish body may provide/use the results visualized in time series order based on the growing day of each of the two proportions based on the corresponding equation.

Both scatter points may also show a linear appearance.

As each growing day increases, the overall-to-head proportion increases and the overall-to-body proportion decreases.

This means that the corresponding proportion tends to increase and decrease as the growing day increases.

The linear relationship may be visualized between the overall-to-body proportion and overall-to-head proportion by growing day for each time series order.

The relationship between the growing day and overall-to-head is 0.62, showing a positive linear relationship, and the relationship between the growing day and overall-to-body may show a negative linear relationship.

This means that the relationship between the two numbers is high, and each has a positive or negative linear relationship. It may be determined that there is a tendency to increase and decrease respectively as the growing day increases.

Information that visualizes the actual length information by growing day using same fish body measurement information used in the corresponding graph may be provided/used. In reality, as the proportion decreases, the growth of the object may be shown to increase.

Through the corresponding indicators, body-based proportion linear regression analysis and head proportion linear regression analysis may be performed, respectively.

$$Y = a + b X$$

The X value used in the regression analysis is the overall-to-body proportion and the overall-to-head proportion, respectively, and the Y value is the same as the growing day.

Using the slope b and intercept a values estimated through the regression analysis, it is possible to estimate the growing day of the object based on the object's proportion value.

However, it is difficult to determine a single value taking into account differences in growth of individual objects. Therefore, it is used as an error verification method for a growing day prediction method based on feature vectors (appearance).

For example, the growing days were predicted to be 300 days as a result through the proportion. Further, the error of the proportion-based growing day prediction method may be +−30 days.

However, the result of feature vector-based growing day prediction may be 315 days. The corresponding growing day may be allowed because it is within the error range based on length proportion. In another example, the feature vector prediction came out to be 350 days. Since this is outside the error range of the prediction method, the corresponding value is a prediction value with low accuracy, so it is not allowed for accuracy.

The above error range may vary depending on the type of object and growth environment.

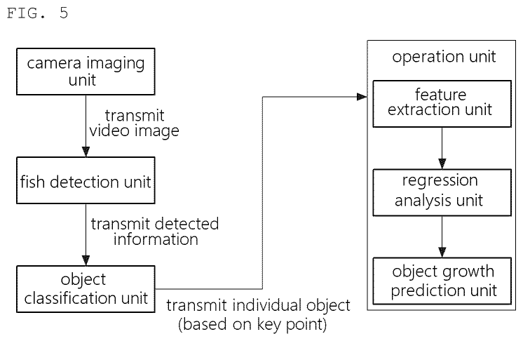

FIG. 5 is a diagram showing a process of a method for estimating a growing day of a fish body according to an embodiment.

According to an embodiment, the device for estimating a growing day of a fish body may include a camera imaging unit, a fish detection unit, an object classification unit, and an operation unit, and the operation unit may further include a feature extraction unit, a regression analysis unit, and an object growth prediction unit, etc.

According to an embodiment, the device for estimating a growing day of a fish body estimates the growing day of the object based on the external appearance information of the object.

In order to obtain the external appearance information, a feature area must be set, and the external appearance information of the object is extracted based on the key points above in the corresponding process.

By performing regression through feature extraction of the object extracted in this way, the growing day of the object is predicted. The process is as follows.

### 1. Image Preprocessing

According to an embodiment, the device for estimating a growing day of a fish body uses an image based on image preprocessing key points as an input.

The interior of the key point, that is, the space outside the object area, is consistently masked with meaningless color information in white or black. The image created in this way is adjusted to a specified size in order to extract the consistent feature vector size of the object. The corresponding size adjustment is different for each object whose growing day is to be predicted. (Atlantic salmon with width 448/height 224 pixel size)

### 2. Normalization Process

According to an embodiment, the device for estimating the growing day of a fish body performs normalization of the corresponding RGB channels because there are differences in the distribution of RGB values in the shooting environment for each image and this affects later feature vectors. Normalization divides the total pixel value by 255 to create a value between 0 and 1. Afterwards, the feature area image is normalized by subtracting the average value for each RGB channel extracted from a large dataset called ImageNet and dividing it by a standard deviation.

The reason for performing the normalization process is to make the distribution of the respective different RGB channels consistent, as shown in the image below.

### 3. Feature Extraction

According to an embodiment, the device for estimating a growing day of a fish body uses a feature extractor based on a convolution technique used in deep learning techniques to extract features.

As shown in the picture below, when normalized image values of 3 channels are input, the values are extracted through a filter and combined to create a feature map. Layered feature extraction is performed repeatedly to obtain a final feature vector value. The size of the feature vector varies depending on the extractor used.

To put it simply, patterns are analyzed with information representing texture, pattern, color, etc. through a convolutional layer.

The regression analysis is performed using the generated feature vectors and growing days.

The regression analysis referred to here uses the growing day as the dependent variable (target) and the feature vector as the independent variable.

As described above, linear regression is performed based on the feature vectors and growing days.

As shown in the figure below, in the linear regression equation, Y (growing days) and X (feature vector) are given, and finding the slope and intercept that optimizes the error is to predict growing days through regression.

$$Y = XB + ε$$

$$( \begin{matrix}{y}_{1} \\ {y}_{2} \\ ⋮ \\ {y}_{n}\end{matrix} ) = ( \begin{matrix}1 & {x}_{11} & {x}_{12} & … & {x}_{1 p} \\ 1 & {x}_{21} & {x}_{22} & … & {x}_{2 p} \\ ⋮ & ⋮ & & & \\ 1 & {x}_{n 1} & {x}_{n 2} & … & {x}_{np}\end{matrix} ) ( \begin{matrix}{B}_{0} \\ {B}_{1} \\ ⋮ \\ {B}_{p}\end{matrix} ) + ( \begin{matrix}{ε}_{1} \\ {ε}_{2} \\ ⋮ \\ {ε}_{n}\end{matrix} )$$

The error formula is as follows.

$$MSE = \frac{1}{N} {\sum }_{i = 1}^{N} {( {Y}_{i} - {\hat{Y}}_{i} )}^{2}$$

N is the number of data, Yi is the actual target value of the ith data, and Ŷᵢ is the predicted value. In other words, the slope and intercept are minimized by minimizing the squared error obtained by squaring a difference between actual and predicted values, and the growing day of the object is estimated based on the feature vector of a new object through the optimized intercept and slope values.

### Specific Process for Deriving Optimal Parameters

According to an embodiment, the device for estimating a growing day of a fish body optimizes the value based on growth data for each growing day.

The target variable for parameter optimization is the value of c. In the case of the b value, it is based on the commonly used value of 0.31, and the maximum, minimum, and optimal temperature are set for weight based on the paper.

The variables are set based on the growth information of objects by rearing temperature organized in time series order, and the value of c is estimated by minimizing the error through the maximum likelihood estimation method.

The formula for calculating the error is as follows. The formula uses squaring the log difference between each actual value and the predicted value.

$$MSLE = \frac{1}{N} {\sum }_{i = 1}^{N} {( log ( {Y}_{i} ) - log ( {\hat{Y}}_{i} ) )}^{2}$$

Through the corresponding process, the value of C that minimizes the error is estimated, and the optimal growth function is completed through the estimated value of C.

### Process for Performing Growth Identification

According to an embodiment, the device for estimating a growing day of a fish body requires initial weight, average rearing temperature, and change in time (days) from the date of initial weight measurement to start weight estimation in order to use the corresponding growth prediction function.

Based on the corresponding variables, the weight and length may be estimated by substituting the variables into the formula above.

The weight and length are each estimated through two optimal parameter derivation processes.

By substituting each variable, biological information such as weight and length after time t is estimated, taking into account differences in optimal temperature, growth rate, etc.

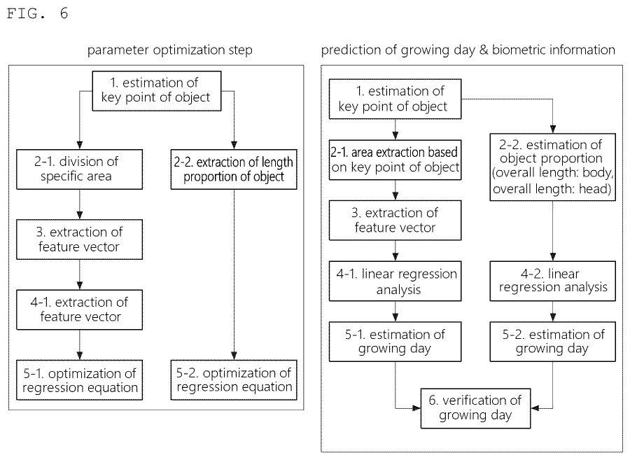

FIG. 6 is a diagram showing a flow of a method for estimating a growing day of a fish body according to an embodiment.

According to an embodiment, the device for estimating a growing day of a fish body performs key point extraction, feature extractor, and linear regression optimization based on the growth information of Atlantic salmon in tanks A and B, and may predict the growing day and biometric information of Atlantic salmon in tank C based on the performance.

There is time series data based on the growing days for Atlantic salmon in tanks A and B. Time series data are images taken of individual objects by the growing day. Based on the corresponding image, the key points are extracted, the feature vectors and length proportions are extracted respectively, and linear regression optimization is performed.

When the regression optimization is performed, the regression slope, intercept, and filter parameters of the feature extractor that minimize each error are estimated. The regression equation is determined based on the estimated parameters.

A new type of Atlantic salmon is being raised in a new environment called C. The user measures biometric information such as weight and length of the object once at the first starting point of rearing of the object and determines the rearing temperature.

Afterwards, the growing day analysis begins using the captured image of the object.

If an image of an object is provided as input data, the key points are found and applied to the image of the object.

The object proportion is extracted using the area extraction through each key point and Nos. 2, 13 and 14 key points.

### Two Sets of Data are FIG.

d in each prediction process.

The proportion of the object predicts the growing day through proportion estimation linear regression analysis, and a verification area is created through the predicted growing day and error interval.

The key point area is extracted and the feature vector is created through feature extraction. By performing the regression analysis with the feature vector as input, the growing day may be predicted. The growing may is verified based on the verification area.

If the verified growing day is within a normal range, the biometric information is estimated after prediction by applying the biometric information prediction function.

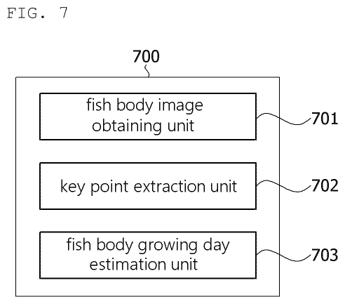

FIG. 7 is a block diagram of a device for estimating a growing day of a fish body according to an embodiment.

According to an embodiment, a device 700 for estimating a growing day of a fish body includes a fish body image obtaining unit 701 that obtains an image of a fish body using a camera, a key point extraction unit that extracts a key point from the obtained image of the fish body, and a fish body growing day estimation unit 703 that estimates a growing day of the fish body based on a length proportion between the key points.

A term of ‘unit’ used in the exemplary embodiment means software or a hardware component such as a field-programmable gate array (FPGA) or ASIC, and ‘unit’ performs predetermined roles. However, ‘unit’ is not a meaning limited to software or hardware. ‘Unit’ may be configured to be positioned in an addressable storage medium and configured to regenerate one or more processors. Therefore, as one example, ‘unit’ includes components such as software components, object oriented software components, class components, and task components, processes, functions, attributes, procedures, subroutines, segments of a program code, drivers, firmware, a microcode, a circuit, data, a database, data structures, tables, arrays, and variables. Functions provided in the components and ‘units’ may be joined as a smaller number of components or further separated into additional components and ‘units’. In addition, the components and ‘units’ may be implemented to regenerate one or more CPUs within a device or a security multimedia card.

The present invention has been described in detail with reference to preferred embodiments thereof. However, it will be appreciated by those skilled in the art that various modifications and changes can be made within the scope without departing from the spirit and the area which are defined in the appended claims and their equivalents.

What is claimed is:

1. A method for estimating a growing day of a fish body, comprising the steps of:
obtaining an image of a fish body using a camera;
extracting a key point from the obtained image of the fish body; and
estimating a growing day of the fish body based on the key point.

2. The method of claim 1, wherein the step of extracting comprises extracting a plurality of the key points from the obtained image of the fish body and the step of estimating comprises estimating the growing day of the fish body based on a length proportion between the key points.

3. The method of claim 1, wherein the step of extracting comprises extracting the key point including a specific area of the fish body from the obtained image of the fish body.

4. The method of claim 3, wherein the step of estimating comprises estimating the growing day of the fish body from a surface area of the specific area.

5. The method of claim 1, wherein the camera comprises at least one single-lens camera.

6. The method of claim 1, wherein the step of extracting comprises extracting an outline point of the fish body.

7. The method of claim 1, wherein the step of estimating comprises estimating the growing day of the fish body using growth curve data.

8. The method of claim 1, wherein the step of estimating comprises estimating a size of the fish body based on the growing day.

9. The method of claim 1, wherein the step of estimating comprises estimating a mass of the fish body based on the growing day.

10. A device for estimating a growing day of a fish body, comprising:
a fish body image obtaining unit that obtains an image of a fish body using a camera;
a key point extraction unit that extracts a key point from the obtained image of the fish body; and
a fish body growing day estimation unit that estimates a growing day of the fish body based on a length proportion between the key points.
